(19) United States
(12) Patent Application Publication
(10) Pub. No.: US 2006/0268040 A1
(43) Pub. Date: Nov. 30, 2006

(54) Image forming system, image forming apparatus and image forming method

(75) Inventors: Masao Kondo, Toyokawa-shi (JP); Kunio Furukawa, Toyokawa-shi (JP); Masafumi Muraki, Toyokawa-shi (JP); Wakemi Yamamura, Toyohashi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies Inc., Tokyo (JP)

(21) Appl. No.: 11/293,243

(22) Filed: Dec. 5, 2005

(30) Foreign Application Priority Data
May 27, 2005 (JP) 2005-155732

(51) Int. Cl. B41J 29/38

(52) U.S. Cl. 347/17

(57) ABSTRACT

An image forming apparatus capable of printing at a transfer voltage and fusing temperature that are suited to a given recording material by including a transfer unit transfers toner images on an image carrier onto a recording material, a fusing unit fuses toner onto the recording material to the images were transferred, a storage unit stores as processing parameter sets at least either the transfer voltages for the transfer unit or the fusing temperatures for the fusing unit that are set to the optimal values for each type of recording material, a controller operates the transfer unit and the fusing unit using a processing parameter set corresponding to the type of recording material selected from among said processing parameter sets stored and a processing parameter obtaining unit obtains processing parameter sets for recording materials that are not stored in the storage unit and stores them in the storage unit.

This application is based on Japanese Patent Application No 2005-155732, filed in Japan on May 27, 2005, the entire content of which is hereby incorporated by reference.

### BACKGROUND OF THE INVENTION

1. Field of the Invention

The present invention relates to an image forming system including an image forming apparatus, image forming apparatus and image forming method.

2. Description of the Related Art

Recent years have seen a trend toward making image forming apparatuses such as electrophotographic printers faster and capable of higher-quality and color image reproduction, and the size of the market has increased. Concurrently, the demands on such apparatuses in terms of required image quality and operating environments have also increased, making it more difficult to provide optimal printing performance in accordance with the desires of all potential users of such printers.

In regard to the surface of the recording material (paper) in particular, the use of coated paper (glossy paper) has become increasingly popular, and many different types of such paper are sold in the market, making it extremely difficult to provide optimal images for all types of recording material.

Consequently, the manufacturers of image forming apparatuses have established recommended paper types, and have further determined, through experimentation using the recommended paper, optimal transfer voltages and fusing temperatures, which are set as default values.

Japanese Patent Laid-Open No. 2003-215865 discloses a technology in which printing parameters such as transfer and fusing parameters are optimized, a service department is notified of these parameters via a communication medium, and the optimal parameters are set in an image forming apparatus based on the data.

However, because it is difficult as a practical matter for a manufacturer to evaluate all recording materials on the market during the design stage and new recording materials enter the market after mass-production has begun in any event, the recording materials actually used by users differ in their characteristics from the paper recommended by the manufacturer, and the optimal settings are not achieved.

Where the settings for the manufacturer-recommended paper such as the transfer voltage and fusing temperature are applied across the board to various types of recording material and printing is performed based thereon, it is difficult to achieve a consistently high level of image quality, and the problem can occur that the user is dissatisfied with the quality of the printed images.

Furthermore, in the technology described in Japanese Patent Laid-Open No. 2003-215865, the recording material is not taken into account during parameter setting, and therefore the above problem is not resolved.

### OBJECT AND SUMMARY

The present invention was devised in consideration of the circumstances described above, and an object thereof is to provide an image forming system, image forming apparatus and image forming method that permit images to be printed using a transfer voltage and fusing temperature that are suited to a given recording material.

In order to achieve the above object, an image forming system comprising an aspect of the present invention is an image forming system including an image forming apparatus, the image forming system further including a transfer unit that transfers toner images on an image carrier onto a recording material, a fusing unit that fuses toner onto the recording material to which such images were transferred, a storage unit that stores as processing parameter sets at least either the transfer voltages for the transfer unit or the fusing temperatures for the fusing unit that are set to the optimal values for each type of recording material, a controller that operates the transfer unit and the fusing unit using a processing parameter set corresponding to the type of recording material selected from among the processing parameter sets stored in the storage unit, and a processing parameter obtaining unit that obtains processing parameter sets for recording materials that are not stored in the storage unit and stores them in the storage unit, wherein the image forming apparatus includes at least the transfer unit, the fusing unit and the controller.

In the image forming system of the present invention, it is preferred that the image forming apparatus include the processing parameter obtaining unit, and that the processing parameter obtaining unit obtain the processing parameter sets at regular intervals.

It is further preferred that the processing parameter obtaining unit of the image forming system of the present invention comprise an information processing device that is connected to the image forming apparatus either directly or over a network, and that the information processing device obtain processing parameter sets at regular intervals.

It is further preferred that the processing parameter obtaining unit of the image forming system of the present invention obtain processing parameter sets over the Internet.

It is further preferred that the processing parameter obtaining unit of the image forming system of the present invention obtain processing parameter sets from a server connected over a network.

It is further preferred that the storage unit of the image forming system of the present invention be incorporated in the image forming apparatus, and that the processing parameter sets obtained by the processing parameter obtaining unit be stored in the storage unit.

It is further preferred that the storage unit of the image forming system of the present invention be incorporated in the information processing device, and that the processing parameter sets obtained by the processing parameter obtaining unit be stored in the storage unit.

It is further preferred that the information processing device of the image forming system of the present invention send the image forming apparatus a print instruction, and that the transmission of a print instruction be accompanied by transmission of a processing parameter set.

In order to achieve the above object, an image forming apparatus of a different aspect of the present invention includes a transfer unit that transfers toner images on an image carrier onto a recording material, a fusing unit that fuses toner onto the recording material to which such images were transferred, a storage unit that stores as processing parameter sets at least the transfer voltages for the transfer unit or the fusing temperatures for the fusing unit that are set to the optimal values for each type of recording material, a controller that operates the transfer unit and the fusing unit using a processing parameter set corresponding to the type of recording material selected from among the processing parameter sets stored in the storage unit, and a processing parameter obtaining unit that obtains processing parameter sets for recording materials that are not stored in the storage unit and stores them in the storage unit.

It is preferred that the image forming apparatus of the present invention have a recording material characteristic obtaining unit that measures either the resistance of the recording material when it passes through the transfer unit or the change in temperature of the recording material when it passes through the fusing unit, and that the processing parameter obtaining unit obtains a processing parameter set based on the recording material characteristic obtained by the recording material characteristic obtaining unit.

It is further preferred that the image forming apparatus of the present invention include a transmission unit that can transmit to an external device the recording material processing parameter sets obtained by the processing parameter obtaining unit.

It is further preferred that the transmission of processing parameter sets by the transmission unit of the image forming apparatus of the present invention be carried out over a network that includes the Internet.

It is further preferred that in the image forming apparatus of the present invention, the recording material processing parameter sets obtained by the processing parameter obtaining unit may be recorded on a removable, transportable recording medium.

In order to achieve the above object, the image forming method of yet another aspect of the present invention include a step in which toner images on an image carrier are transferred onto a recording material, a step in which toner is fused onto the recording material onto which toner images were transferred, a step in which a processing parameter set suited to the type of recording material is selected from the storage unit that stores processing parameter sets each comprising at least either one of a transfer voltage for the transfer step or a fusing temperature for the fusing step that is set to the optimal value depending on the type of recording material, and transfer and fusing are then carried out, and a step in which processing parameter sets for recording materials that are not stored in the storage unit are obtained and stored in the storage unit.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a drawing showing the construction of an image forming system pertaining to an embodiment of the present invention;

FIG. 2 is a block diagram showing the construction of a printer used in the system shown in FIG. 1;

FIG. 3 comprises flow charts of a media information obtaining routine executed by the printer shown in FIG. 2;

FIG. 4 is a drawing showing the construction of an image forming system pertaining to a different embodiment of the present invention;

FIG. 5 is a drawing showing the basic construction of the printing unit of a printer;

FIG. 6 is a timing chart that applies during transfer characteristic measurement;

FIG. 7 is a graph showing the relationship between the detected voltage during transfer characteristic measurement and the thickness of the recording material;

FIG. 8 is a flow chart showing a transfer voltage measurement routine;

FIG. 9 is a timing chart applicable during fusing characteristic measurement;

FIG. 10 is a graph showing the relationship between the decline in temperature during fusing characteristic measurement and the set temperature;

FIG. 11 is a timing chart applicable to during heater control in connection with temperature decline; and

FIG. 12 is a drawing showing the construction of an image forming system comprising still another embodiment of the present invention.

### DETAILED DESCRIPTION OF THE PREFERRED EMBODIMENTS

Embodiments of the present invention will be described below based on the drawings.

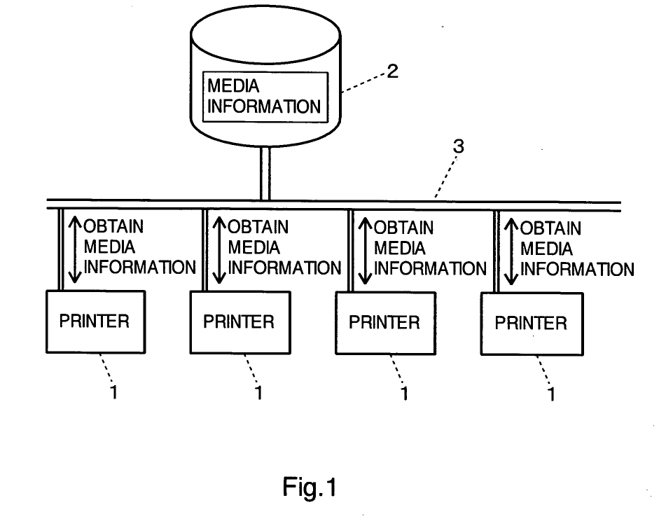

FIG. 1 is a drawing showing the construction of an image forming system pertaining to an embodiment of the present invention.

This image forming system consists of multiple printers 1 comprising image forming apparatuses and a database server 2 that are connected to each other over a network 3 such as the Internet or a LAN.

The database server 2 comprises a Web server or shared server, which is managed by a manufacturer, for example, and is a database in which, each time a new recording material (in the discussion below, ‘recording material’ may also be expressed as ‘medium’ or ‘paper’) appears following printer shipment, information regarding such medium and optimal processing parameter information that is set for that medium are registered and stored. Each printer 1 can access the database server 2 over the network 3.

For the purposes of this embodiment, a processing parameter set may comprise at least one of either the transfer voltage for the transfer unit or the fusing temperature for the fusing unit of the printer 1, but the processing parameter set used in this embodiment includes, in addition to the transfer voltage and fusing temperature (fusing roller set temperature) for each medium, the transfer roller nip amount, the transfer roller pressure, the fusing roller nip amount, the fusing roller pressure, the fusing heater duty ratio, the paper interval and the like.

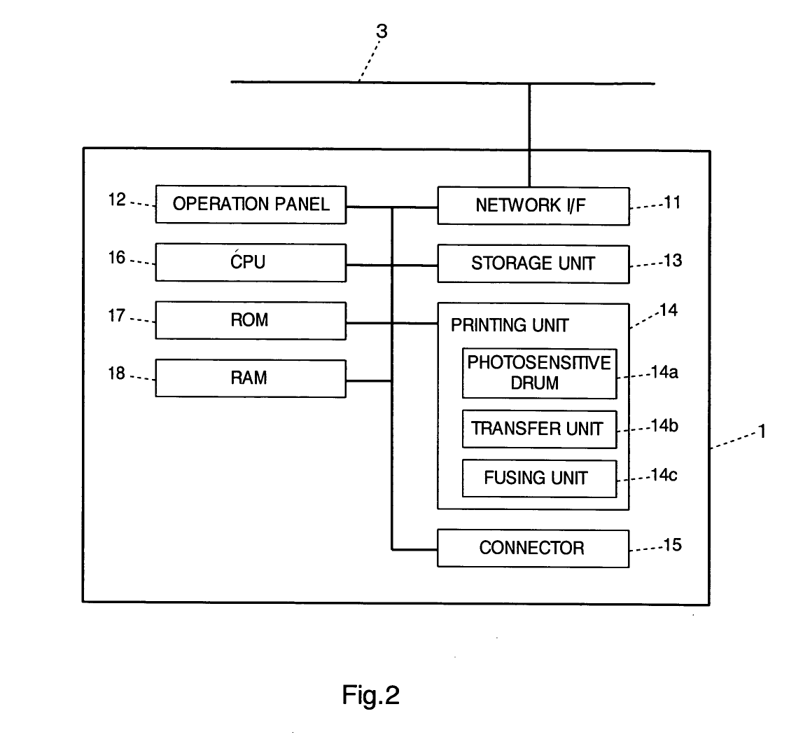

FIG. 2 is a block diagram of each printer 1 used in the image forming system shown in FIG. 1.

Each printer 1 includes a network interface (termed a ‘network I/F’ in the drawing) 11, an operation panel 12, a storage unit 13, a printing unit 14, a connector 15, a CPU 16, a ROM 17, a RAM 18 and the like.

The network interface 11 carries out communication between the database server 2 and an external device such as a user terminal.

The operation panel 12 includes a key operation unit comprising a numeric keypad, a start key and the like, as well as a touch panel-type LCD display, and is used for user input of a copy job or the display of the status of the apparatus.

The storage unit 13 comprises a hard disk, for example, and in this embodiment, in addition to storing various types of data, it stores at the time of printer shipment representative media types and processing parameter sets for each such media type. It further stores new media types obtained from the database server 2 and processing parameter sets therefore.

The printing unit 14 prints print data transmitted from a user terminal. The printing unit 14 has a public-domain construction and includes such components as a photosensitive drum 14a or an intermediate transfer body comprising a toner image carrier, a transfer unit 14b that transfers toner images to a medium, and a fusing unit 14c that fuses the transferred toner.

The connector 15 connects a portable external storage medium such as a USB (Universal Serial Bus) memory or a CD-ROM, and enables the storage of information in the storage unit 13 from a connected external storage medium or the recording of information read out from the storage unit 13 in an external storage medium.

The CPU 16 carries out overall control of the printer 1. For example, it operates the printing unit 14 such that the printing unit 14 performs printing onto a printing medium using a processing parameter set corresponding to the user-specified medium. It also accesses the database server 2 when the power is turned ON or at regular intervals thereafter, obtains information such as media types not stored in the storage unit 13 and the processing parameter sets therefore (hereinafter referred to as ‘media information’) and stores this media information in the storage unit 13.

The ROM 17 stores programs and the like executed by the CPU 16, and the RAM 18 serves as a work area used when the CPU 16 executes such programs.

In the image forming system shown in FIG. 1, the user sets the printing medium in the paper feed unit of the printer 1 and enters a print job from a user terminal, for example, after specifying the media type. When this occurs, the processing parameter set corresponding to that media type is retrieved from the storage unit 13 and printing is executed using that processing parameter set. The media type may be specified either via inclusion in the print job sent from the user terminal or via the operation panel 12 of the printer.

Furthermore, the printer 1 accesses the database server 2 when the power is turned ON or at regular intervals thereafter, and when information regarding media types not stored in the storage unit 13 is registered in the database server 2, the printer 1 obtains that media information and stores it in the storage unit 13.

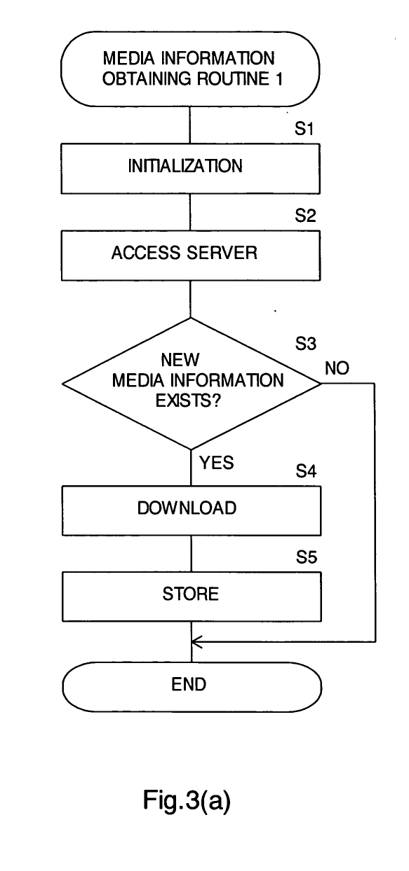

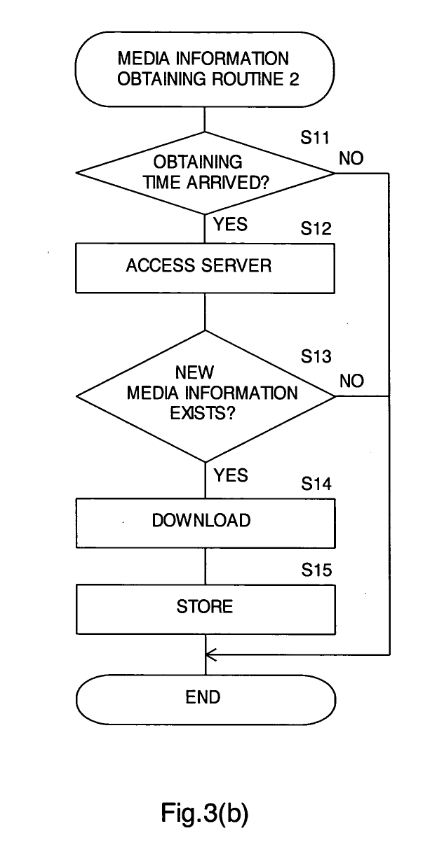

FIG. 3(a) is a flow chart showing a routine that is carried out to obtain media information and is executed by the CPU 16 of the printer 1 when the power is turned ON.

When power to the printer 1 is turned ON, the CPU 16 executes an initialization routine in step S1 and accesses the database server 2 in step S2.

In step S3, the CPU 16 checks whether or not media information that is not stored in the storage unit 13 is registered in the database server 2, and if such media information is registered (YES in step S3), the CPU 16 obtains that media information via downloading in step S4, and ends processing after storing the media information in the storage unit 13 in step S5. If it is determined in step S3 that no media information that is not stored in the storage unit 13 is registered in the database server 2 (NO in step S3), processing ends.

FIG. 3(b) is a flow chart showing a routine that is carried out to obtain media information and is executed by the CPU 16 of the printer 1 at regular intervals during operation of the printer 1.

In step S11, the CPU 16 checks whether or not a preset information obtaining time has arrived, and if it has (YES in step S11), it accesses the database server 2 in step S12. In step S13, the CPU 16 checks whether or not media information that is not stored in the storage unit 13 is registered in the database server 2, and if such media information is registered (YES in step S13), the CPU 16 obtains such media information via downloading in step S14, and ends processing after storing the media information in the storage unit 13 in step S15. If it is determined in step S11 that an information obtaining time has not arrived (NO in step S11), or if it is determined in step S13 that no media information that is not stored in the storage unit 13 is registered in the database server 2 (NO in step S13), processing ends.

Because the printer 1 accesses the database server 2 either on startup or at regular intervals thereafter, and obtains media information that is not stored in the storage unit 13 in this way, not only information regarding media registered at the time of shipment of the printer 1, but also information regarding media that are not registered at the time of shipment and media that appear on the market thereafter, can be sequentially added to the storage unit 13 of the printer 1. In other words, the printer is always in a learning state. As a result, printing can be performed based on the optimal processing parameters for the media type used by the user, such that the user can obtain high-quality printed images conforming to the characteristics of the desired media type.

Incidentally, the timing at which the media information is obtained is not limited to either on printer startup or at regular intervals thereafter. It may be obtained at both such times, or at a time or times designated by the user.

Furthermore, while the printer 1 accesses the database server 2 and obtains media information in the description above, it may alternatively obtain the media information via a portable external storage medium such as a USB memory or CD-ROM that stores media information. For example, it is acceptable if an installation program is started automatically when a USB memory is connected to the connector 15 of the printer 1 and media information is then stored in the storage unit 13 of the printer

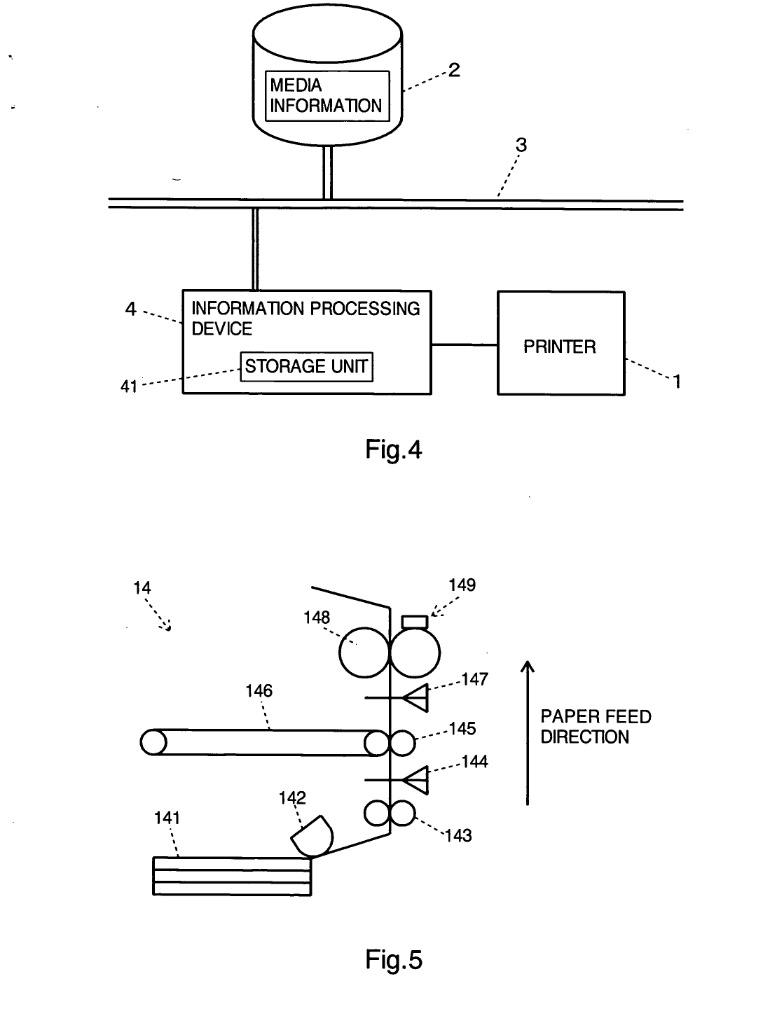

FIG. 4 is a drawing showing the construction of an image forming system pertaining to a different embodiment of the present invention.

In this embodiment, the database server 2 is connected to an information processing device 4 comprising a personal computer or the like over a network 3 such as the Internet or a LAN, and the printer 1 is connected directly to the information processing device 4.

In the image forming system shown in FIG. 1, the printer 1 obtained new media information from the database server 2, but in the image forming system shown in FIG. 4, the information processing device 4 accesses the database server 2 and obtains media information therefrom on startup and/or at regular intervals thereafter and/or at a user-specified time or times.

The obtained media information is then stored in the storage unit 41 of the information processing device 4. Therefore, media information regarding media that are not registered at the time of shipment or regarding new media are added sequentially to the storage unit 41 of the information processing device 4. As a result, printing can be performed based on the optimal processing parameters for the media type used by the user, and the user can obtain high-quality printed images conforming to the characteristics of the desired media type.

The media information obtaining routine of this second embodiment is identical to the routine shown in the flow chart of FIG. 3.

The information processing device 4 can send print instructions to the printer 1 via user operation as well as select existing or added media via a printer driver, and when a print instruction is sent, the media information for the media type used by the user is also provided via the use of the printer driver.

Because the number of media types is increasing constantly, a potential concern is that it is time-consuming for the user to individually select the desired media type using a printer driver, but this problem is solved by, once the user has selected a media type, giving that selection priority over all other media types or enabling the user to customize the media selection screen by hiding unnecessary media types.

Specifically, if selection is made from a pull-down menu, it is acceptable if media that have been used by the user are rearranged on the display based on the use history such that the latest used medium is placed on top, or unused media are placed together under the category of ‘other media’ and a pull-down sub-menu is made available when ‘other media’ menu item is selected.

When the printer 1 receives a print instruction and media information, it performs printing on the medium set by the user based on the received processing parameter set. As a result, printing can be carried out using the optimal processing parameters for the media type used by the user, and the user can obtain high-quality printed images conforming to the characteristics of the desired media type.

Incidentally, while the information processing device 4 sends print instructions and media information to the printer 1, it may alternatively be constructed such that it sends the media information to the printer 1 at the moment that it obtains it from the database server 2.

Furthermore, while the information processing device 4 obtained media information by accessing the database server 2, it may alternatively obtain the media information via connection of a portable external storage medium such as a USB memory or a CD-ROM that stores media information to the information processing device 4. For example, a construction may be adopted wherein when a USB memory is connected to the information processing device 4, an installation program is automatically started up and the media information is stored in the storage unit 41 of the information processing device 4.

Moreover, while the printer 1 is connected directly to the information processing device 4 in the system shown in FIG. 4, the printer 1 may instead be connected to the information processing device 4 over a network 3.

Yet another embodiment of the present invention will now be described.

In this embodiment, media information is obtained via measurement of the characteristics of the media type by the printer 1.

In other words, because the optimal parameter sets for media types that are not registered in the printer 1 at the time of shipment and media types that appear on the market after shipment are not stored in the storage unit 13 of the printer 1, printing is carried out via a media characteristic measurement routine in which a media characteristic such as the resistance or temperature characteristic of the media is measured and the optimal printing parameters are thereafter determined by the printer 1 on its own.

In the media characteristic measurement routine, a new media type is registered in the printer 1 and the optimal processing parameters for the registered media are set and stored in the storage unit 13 of the printer 1.

At least one of the two methods below may be applied as the media characteristic measurement routine.

(1) Optimization of Transfer Settings via Transfer Characteristic Measurement

FIG. 5 shows the construction of the essential elements of the printing unit 14 of the printer 1, which includes transfer rollers 145 that impress transfer voltage, a paper sensor 144 disposed upstream from the transfer rollers 145, a constant-current output apparatus that outputs a constant current to the transfer rollers 145 within the permissible output range (not shown in the drawing), and a voltage measurement device (also not shown) that can measure the voltage flowing between the transfer rollers 145.

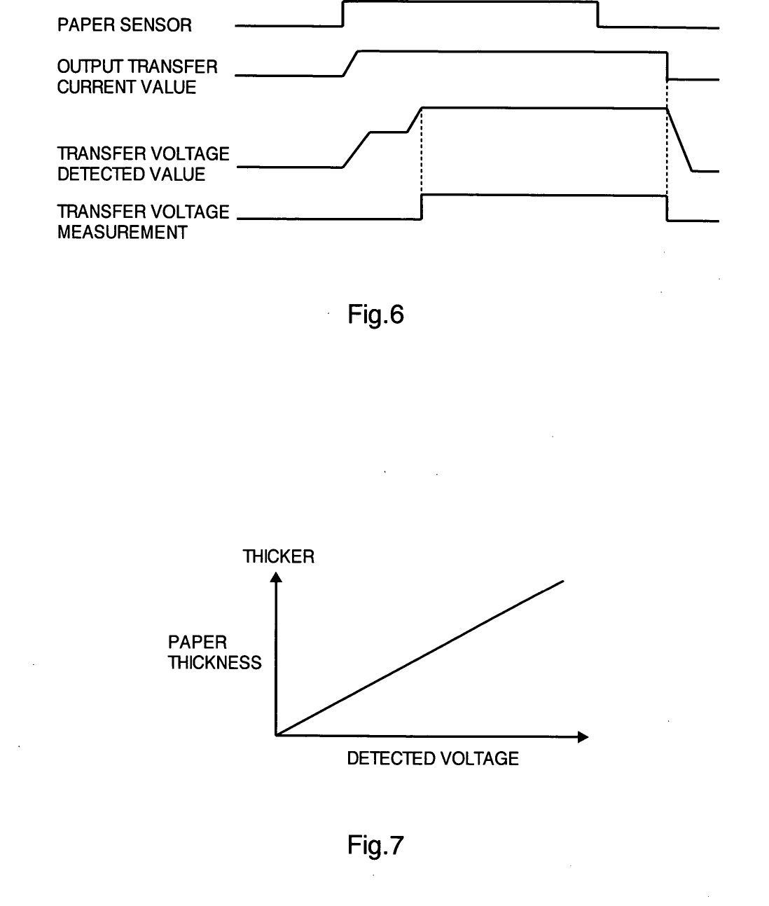

In this printer 1, without performing image formation, a printing medium is supplied from the paper feed tray 141 by the pickup roller 142, and as shown in the timing chart of FIG. 6, constant-current output is begun simultaneously with detection that the paper sensor 144 is in the ON state. The constant-current output may be begun at any time so long as the output current level stabilizes by the time that the printing medium reaches the transfer rollers 145.

Voltage measurement begins a prescribed period of time after detection that the paper sensor 144 is in the ON state. This prescribed period of time is the sum of the time that is required for the printing medium to travel from the paper sensor 144 to the transfer rollers 145 and the time between the insertion of the printing medium into the transfer rollers 145 and the point in time at which the voltage level reaches a stable state. Voltage levels are measured at regular intervals after the commencement of voltage measurement and are stored in the storage unit 13. Voltage measurement is ended a prescribed period of time following that the paper sensor 144 is in the OFF state. This prescribed period is the time required for the printing medium to travel from the paper sensor 144 to the transfer rollers 145. Once measurement is completed, the voltage levels stored in the storage unit 13 is averaged and the resistance of the printing medium is calculated.

From the voltage and resistance values obtained via the above measurement, the processing parameters described below, for example, may be calculated and applied during printing. In other words, as the resistance increases, the transfer voltage required in order to maintain the proper transfer characteristics increases as well. The optimal transfer voltage parameter can be calculated based on the measurement results and be stored in the storage unit 13 as the set transfer voltage parameter for the measured media type such that it can be applied during printing.

Moreover, because the transfer resistance is proportional to the paper thickness as a general rule, for media that have undergone identical processing, it can be determined that the paper increases in thickness as the transfer resistance increases and decreases in thickness as the transfer resistance decreases. FIG. 7 is a graph showing the relationship between detected voltage and paper thickness.

Based on the measurement results, the paper thickness of the printing medium can be calculated, whereby the optimal fusing roller nip amount can be calculated and stored in the storage unit 13 as the fusing roller nip parameter for the measured medium, thereby enabling the pressure contact/separation mechanism that controls the nip amount of the fusing rollers 148 during printing to be operated such that the nip amount increases as the paper thickness decreases.

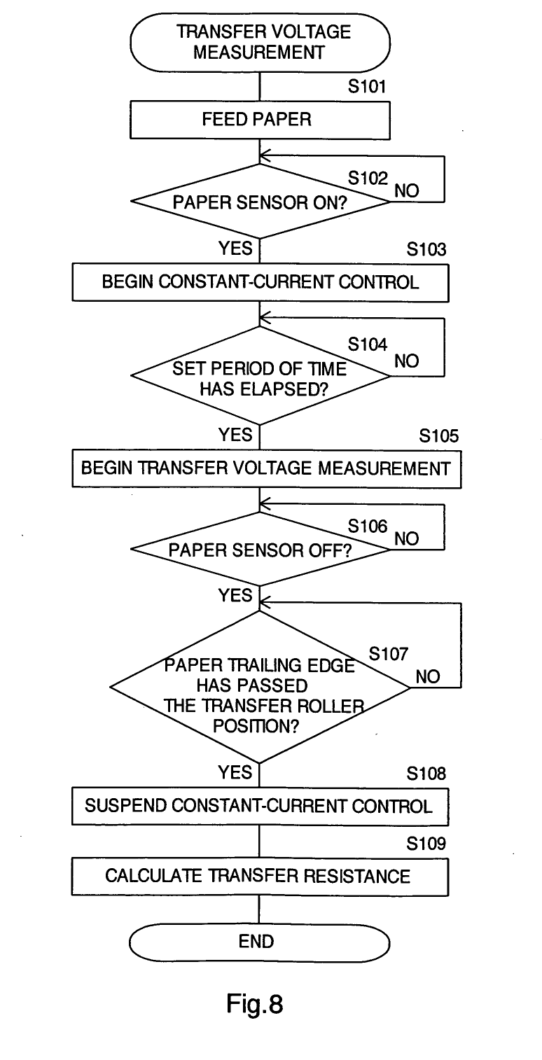

FIG. 8 is a flow chart showing the transfer voltage measurement routine.

In step S101, the printing medium is supplied from the paper feed tray 141 via the pickup roller 142. After paper feeding, the CPU 16 waits until the paper sensor 144 enters the ON state in step S102, and if the ON state is present (YES in step S102), constant current is impressed to the transfer rollers 145 in step S103.

In step S104, the CPU 16 waits for a period of time comprising the sum of the time required for the printing medium to reach the transfer rollers 145 from the paper sensor 144 and the time required for the transfer voltage to stabilize, and when this period of time has elapsed (YES in step S104), constant-voltage measurement is begun in step S105. The CPU 16 thereafter waits for the trailing edge of the printing medium to set the paper sensor 144 to OFF in step S106, and when the trailing edge of the printing medium sets the paper sensor 144 to OFF (YES in step S106), the CPU 16 waits for the trailing edge of the paper to pass through the transfer rollers 145 in step S107. After the trailing edge of the paper has passed through the transfer rollers 145 (YES in step S107), constant-voltage measurement is suspended in step S108. Once the transfer voltage measurement is completed, the average of the sampled measurement values, which were taken at certain intervals in step S109, is calculated to compute the transfer resistance, whereupon the measurement routine ends.

(2) Optimization of Fusing Temperature via Fusing Characteristic Measurement

The printing unit 14 of the printer 1 includes a fusing roller 148 that applies heat to the printing medium to fuse toner thereon, a paper sensor 147 disposed upstream from the fusing roller 148, and a thermistor 149 that can measure the surface temperature of the fusing roller 148, as shown in FIG. 5.

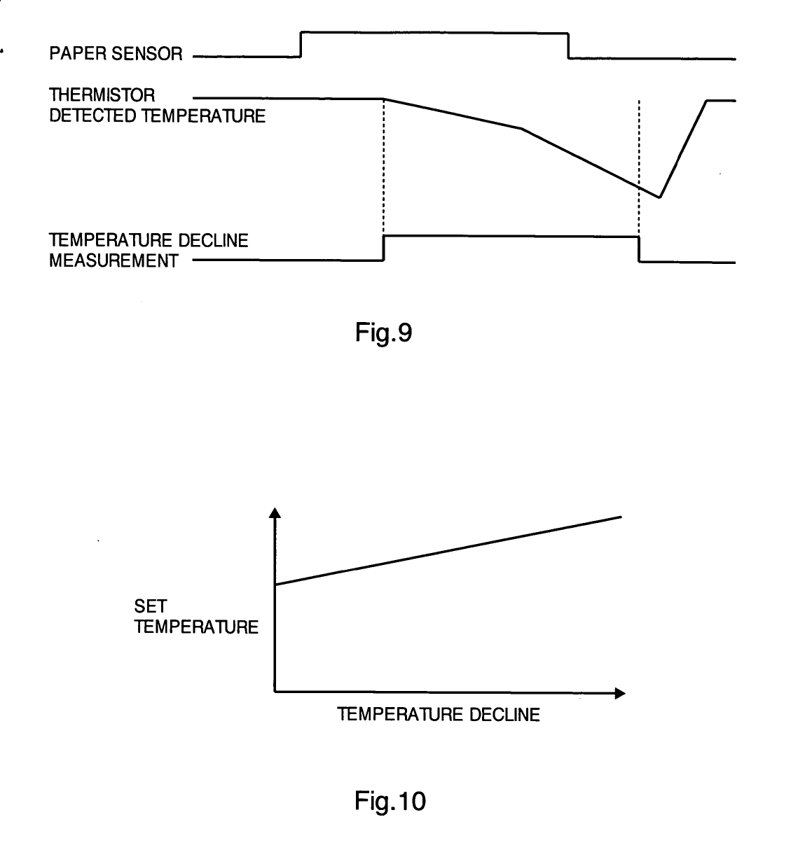

The printing medium is fed from the paper feed tray 141 via the pickup roller 142 without images being formed thereon, and as shown in the timing chart of FIG. 9, temperature decline measurement is begun a prescribed period of time after detection that the paper sensor 147 is in the ON state. This prescribed period of time is the time that the printing medium takes to travel from the paper sensor 147 to the fusing roller 148.

The temperature detected by the thermistor 149 at the commencement of measurement is stored in the storage unit 13. Measurement of the decline in temperature is ended after a prescribed period of time following detection that the paper sensor 147 is in the OFF state. The prescribed period of time is the time that the printing medium takes to travel from the paper sensor 147 to the fusing roller 148. The decline in temperature is calculated by subtracting the temperature detected by the thermistor 149 when measurement ends from the temperature detected by the thermistor 149 when measurement begins, thereby revealing the printing medium temperature decline amount.

The processing parameter described below, for example, is calculated from the temperature decline value obtained through the above measurement and applied during printing.

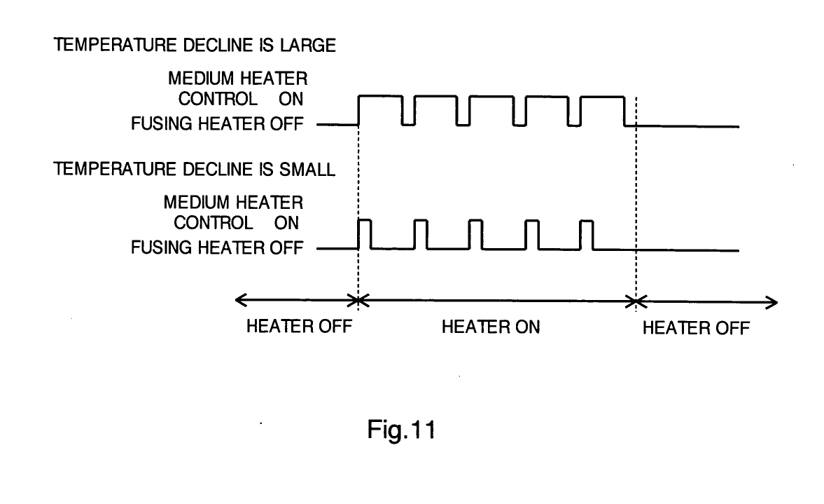

As shown in FIG. 10, where the temperature decline is large, a high temperature setting is necessary in order to prevent the temperature from reaching an undesirably low level. Based on the measurement results, the optimal fusing temperature is calculated and stored in the storage unit 13 as the temperature setting parameter for the measured printing medium, enabling it to be applied as the set temperature for the fusing roller 148 during printing. As shown in FIG. 11, it is also effective to set the fusing heater ON/OFF duty ratio to a high setting in order to prevent temperature decline.

Based on the measurement results, the optimal fusing heater duty value can be calculated and stored in the storage unit 13 as the fusing heater duty value parameter for the measured media type and applied as the duty ratio when the fusing heater is turned ON during printing. Where the temperature decline is large, if the fusing heater duty value shown in FIG. 11 is applied, because the heater ON time is long, there is an extreme rise in temperature at the ends of the fusing rollers 148 through which no paper passes. In order to prevent this rise in temperature, a sufficient paper interval is required. Based on the measurement results, the optimal paper interval can be calculated and stored in the storage unit 13 as the paper interval parameter for the measured media type, as well as applied during printing as the paper feed interval.

As described above, for media types regarding which no media information is stored in the storage unit 13 of the printer 1, the printer 1 measures the characteristics of the media type, and based thereon, the optimal processing parameters for that media type are set and stored in the storage unit 13 as media information. Therefore, not only information regarding media registered at the time of shipment of the printer 1, but also information regarding media that are not registered at the time of shipment and media that appear on the market thereafter, can be sequentially added to the storage unit 13 of the printer 1. As a result, printing can be performed based on the optimal processing parameters for the media type used by the user, and the user can obtain high-quality printed images conforming to the characteristics of the desired media type.

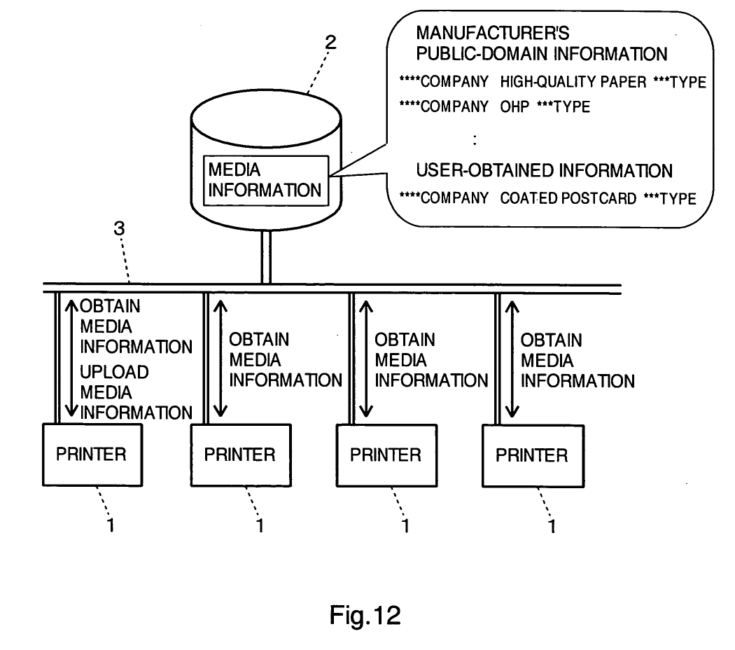

As shown in FIG. 12, the media information obtained by the printer 1 on its own as described above may be uploaded and publicly disclosed via the network 3 such as the Internet or a LAN. As a result, the media information can be provided to other users using the same model of printer. Such information may be treated as if it were prepared by the manufacturer, or may be treated differently as media information obtained by the printer 1 on its own. Furthermore, for media information uploaded from the printer 1, it is preferred that it be downloaded as a result of user selection rather than being downloaded automatically by the printer 1 or information processing device 4.

The information uploaded from the printer 1 may be uploaded to either the database server 2 provided by the manufacturer or to a different printer connected to an office network or the Internet. Furthermore, a USB memory, CD-ROM or other portable storage medium may be used as the communication means, and the media information stored in the storage unit 13 of the printer 1 may be retrieved and stored in the portable storage medium, which then may be connected to a different printer such that the information may then be provided thereto.

The media information to be provided preferably includes not only the media type and processing parameters, but also information enabling identification of the manufacturer and the printer model, such as a manufacturer ID and model ID (a code that enables identification of the model). Providing such information enables determination of whether or not the provided media information comprises information for the same model of printer.

When the information obtained by the printer 1 on its own is made public, it is extremely troublesome for the user to find out and register the name of the media type, and it is unrealistic to expect the user to do this. Accordingly, a bar code or two-dimensional bar code printed on the package (wrapper) of the medium, for example, may be read using a reader, or a code printed on the printing medium together with the bar code could be input.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

An image forming system that includes a printer. Processing parameter sets each comprising at least one of either the transfer voltage or the fusing temperature for the printer, which is set to the optimal value depending on the type of recording medium, are stored in a storage unit, and the transfer unit or fusing unit is operated based on a processing parameter set suited to the type of recording material and selected from among the stored processing parameter sets. The image forming system includes a processing parameter value obtaining unit that obtains and stores in the storage unit processing parameter values for recording materials whose processing parameter values are not stored in the storage unit.

What is claimed is:

1. An image forming system including an image forming apparatus comprising:
a transfer unit that transfers toner images on an image carrier onto a recording material;
a fusing unit that fuses toner onto the recording material to the images were transferred;
a storage unit that stores as processing parameter sets at least either the transfer voltages for the transfer unit or the fusing temperatures for the fusing unit that are set to the optimal values for each type of recording material;
a controller that operates the transfer unit and the fusing unit using a processing parameter set corresponding to the type of recording material selected from among the processing parameter sets stored in the storage unit; and
a processing parameter obtaining unit that obtains processing parameter sets for recording materials that are not stored in the storage unit and stores them in the storage unit,
wherein at least the transfer unit, the fusing unit and the controller are incorporated in the image forming apparatus.

2. The image forming system according to claim 1, wherein said processing parameter obtaining unit is incorporated in the image forming apparatus, and that the processing parameter obtaining unit obtains the processing parameter sets at regular intervals.

3. The image forming system according to claim 1, wherein said processing parameter obtaining unit comprises an information processing device that is connected to the image forming apparatus either directly or over a network, and that the information processing device obtains processing parameter sets at regular intervals.

4. The image forming system according to claim 2, wherein said processing parameter obtaining unit obtains processing parameter sets over the Internet.

5. The image forming system according to claim 3, wherein said processing parameter obtaining unit obtains processing parameter sets over the Internet.

6. The image forming system according to claim 2, wherein said processing parameter obtaining unit obtains processing parameter sets from a server connected over a network.

7. The image forming system according to claim 3, wherein said processing parameter obtaining unit obtains processing parameter sets from a server connected over a network.

8. The image forming system according to claim 2, wherein said storage unit is incorporated in the image forming apparatus, and that the storage unit stores the processing parameter sets obtained by the processing parameter obtaining unit.

9. The image forming system according to claim 3, wherein said storage unit is incorporated in the information processing device, and that the storage unit stores the processing parameter sets obtained by the processing parameter obtaining unit.

10. The image forming system according to claim 9, wherein said information processing device sends the image forming apparatus a print instruction, and that a transmission of the print instruction is accompanied by a transmission of the processing parameter set.

11. An image forming apparatus comprising:
a transfer unit that transfers toner images on an image carrier onto a recording material;
a fusing unit that fuses toner onto the recording material to the images were transferred;
a storage unit that stores as processing parameter sets at least either the transfer voltages for the transfer unit or the fusing temperatures for the fusing unit that are set to the optimal values for each type of recording material;
a controller that operates the transfer unit and the fusing unit using a processing parameter set corresponding to the type of recording material selected from among the processing parameter sets stored in the storage unit; and
a processing parameter obtaining unit that obtains processing parameter sets for recording materials that are not stored in the storage unit and stores them in the storage unit.

12. The image forming apparatus according to claim 11, wherein said processing parameter obtaining unit obtains processing parameter sets over the Internet.

13. The image forming apparatus according to claim 11, wherein said processing parameter obtaining unit obtains processing parameter sets from a server connected over a network.

14. The image forming apparatus according to claim 11, further comprising a recording material characteristic obtaining unit that measures either a resistance of the recording material when it passes through the transfer unit or a change in temperature of the recording material when it passes through the fusing unit,
wherein said processing parameter obtaining unit obtains a processing parameter set based on the recording material characteristic obtained by the recording material characteristic obtaining unit.

15. The image forming apparatus according to claim 14, further comprising a transmission unit that transmits to an external device the processing parameter sets about the recording material obtained by the processing parameter obtaining unit.

16. The image forming apparatus according to claim 15, wherein said transmission unit transmits processing parameter sets over a network that includes the Internet.

17. The image forming apparatus according to claim 14, wherein the processing parameter sets about the recording material obtained by the processing parameter obtaining unit are recorded on a removable, transportable recording medium.

18. An image forming method comprising steps of:
a step in which toner images on an image carrier are transferred onto a recording material;
a step in which toner is fused onto the recording material onto which toner images were transferred;
a step in which a processing parameter set suited to the type of recording material is selected from the storage unit that stores processing parameter sets each comprising at least either one of a transfer voltage for the transfer step or a fusing temperature for the fusing step that is set to the optimal value depending on the type of recording material, and transfer and fusing are then carried out; and
a step in which processing parameter sets for recording materials that are not stored in the storage unit are obtained and stored in the storage unit.

19. An image forming program for executing the steps according to claim 18 on a computer.

20. A storage medium readable by a computer in which the image forming program according to claim 19 is stored.
